(19) United States
(12) Patent Application Publication
(10) Pub. No.: US 2019/0045443 A1
(43) Pub. Date: Feb. 7, 2019

(54) COMMUNICATIONS PROTOCOL FOR DATA TRANSMISSION

(71) Applicant: Giancarlo Bregante, Sunrise, FL (US)

(72) Inventor: Giancarlo Bregante, Sunrise, FL (US)

(21) Appl. No.: 16/059,031

(22) Filed: Aug. 8, 2018

Related U.S. Application Data
(63) Continuation of application No. 15/427,752, filed on Feb. 8, 2017.

(30) Foreign Application Priority Data
Feb. 8, 2017 (CA) 2,957,398
Feb. 8, 2017 (GB) 1802006.5

(51) Int. Cl. H04W 52/02; H04W 76/27; G06K 7/10; G06K 19/077; G06Q 10/08; H04B 5/00; G06K 19/07

(52) U.S. Cl. CPC H04W 52/0229; H04W 76/27; G06K 7/10158; G06K 19/07758; G06K 19/0702; H04B 5/0062; G06Q 10/087

(57) ABSTRACT

Inventory tracking systems and methods are provided herein that utilize a communication protocol that provides randomized parameters to ensure transmission between two or more remote devices and a central device. Remote devices enter a sleep mode for a randomized sleep period, and then enter a power-on mode after the period of sleep time has elapsed. When in the power-on mode, the remote device listens and identifies whether a beacon message is sent from the central device. If a beacon message is detected, the remote device sends a return message and then returns to sleep mode. If a beacon message is not detected, the remote device returns to sleep mode.

### CROSS-REFERENCE TO RELATED APPLICATION

This application is a continuation-in-part of application Ser. No. 15/427,752 filed Feb. 8, 2017.

### FIELD OF THE INVENTION

The present invention generally relates to a communications protocol. More specifically, the present invention comprises systems and methods for a communication protocol that utilizes randomized parameters to ensure transmission between one or more remote devices and one or more central devices. This communication protocol can be applied to inventory systems, medical systems, agriculture systems and any ecosystem where tracking is required to be implemented.

### BACKGROUND OF THE INVENTION

Inventory of all types may be stored in large quantities within a warehouse or other containment area. Inventory generally consists of items such as raw materials, works in progress, or finished goods that are stored and meant to be either rented or sold at some time in the near future.

With large quantities of inventory stored, a need arises to correctly track each item. Radio-frequency identification (RFID) is a known system that utilizes an electromagnetic field to automatically identify and track tags attached to inventory items. However, RFID systems run into problems when there are many inventory items and, therefore, many tags. This is especially so when the items are also located in a small area.

More specifically, RFID systems require that data be transferred across specific frequencies of the electromagnetic spectrum between tags placed on inventory items and a central device or hub. When many tags are present, there is a likelihood that packet collisions occur as multiple tags attempt to send packetized data to the central device simultaneously. This problem occurs when the central device attempts to read a large number of inventory tags at the same time and on the same frequency and is exacerbated when tags are centralized in a small area. When packet collisions occur, data from the tagged inventory item is not received by the central device and the data must be resent or the data loss results in incorrect inventory tracking.

Further, RFID tags generally employ batteries, which allow the range of the system in which they are employed to be increased. Unfortunately, repeated attempts by tags to send data to central device may quickly wear down these batteries, especially if data must be resent multiple times due to the occurrence of tag collisions. Battery life is also quickly drained if the inventory tags are constantly powered on, listening for a signal from the central hub, and waiting to respond.

### SUMMARY OF THE INVENTION

It is to be understood that in the present disclosure, all embodiments are provided as illustrative and non-limiting representatives of as many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as communication, wireless, data, inventory etc., are herein meant to include or encompass all equivalents for such elements. For example, in addition to a “inventory”, any collection of information is also contemplated by the present invention.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for a communications protocol method and system. The general purpose of the present invention, which shall be described subsequently in greater detail, is to enable a user to utilize randomized parameters to ensure transmission between one or more remote devices and one or more central devices. The features of the invention are believed to be novel and to have been particularly pointed out and distinctly claimed in the concluding portion of the specification. These and other features, aspects, and advantages of the present invention will become better understood with reference to the following drawing and detailed description.

The features of the invention which are believed to be novel are particularly pointed out and distinctly claimed in the concluding portion of the specification. By way of non-limiting example, the present invention provides a novel solution for a communications protocol method and system. These and other features, aspects, and advantages of the present invention will become better understood with reference to the following drawings and detailed description.

There is therefore provided an inventory tracking method and system which allows periodic transmission between remote devices and central devices to take place at random points in time. By randomizing when a device transmits, collisions amongst device transmissions that take place when multiple devices transmit on the same frequency at the same time. The present invention relates to a wireless or wired communication protocol that allows for communication between Remote Devices (hereinafter referred also as Tags) and Central Devices (hereinafter referred also as Gateways).

Because of the nature of the communication protocol of the present invention, Tags may be simple remote devices that are easily and inexpensively manufactured. The Tags of the present invention require minimal memory and processing power, which are factors that further extend the battery life of the devices.

The Tags are not required to be constantly “awake” and listening for messages from the Gateway to respond to. If the Tags are programmed to only wake up and listen at certain intervals, the battery life of the Tags may be improved.

Tags may be attached to items to be tracked to determine whether the items are proximate a Gateway. When Tags are proximate at least one Gateway, the periodic transmissions between Tags and Gateway allow the system to know that a tag is in the vicinity. When a period of time has elapsed and a particular Tag has not communicated with a Gateway, then the system knows that the Tag is no longer in the vicinity. In this way, Tags may be used to keep track of items. The system will be described in greater detail below.

The communication protocol of the present invention is intended to allow the guaranteed transmission of a data payload sent by a plurality of Tags during a certain time period. The communication protocol allows data packets, comprising, amongst other information, Tag identification information to be sent from Tags to Gateways more efficiently while avoiding time consuming steps, such as handshakes that require an exchange of information via transmissions between Tags and Gateways. The communication protocol enables energy savings at any given Tag during the transmission process while also sending the payload from Tags to Gateways as often as possible in order to update the Tags' status. Energy is saved as the number of transmissions of a payload required to guarantee that transmission has been received by a Gateway is minimized.

The data payload sent by a particular Tag is made up of one or more data packets. The payload can be received at the same time by one or more Gateways, depending on how the overall system's topology and configuration are implemented at a specific site (e.g. at a warehouse). In one embodiment, data packets received by the Gateways may be collectively sent to an Inventory Server where they may be filtered (for example, by eliminating duplicate or repeated data packets received from the same Tag) and processed to properly update the inventory system. The Inventory Server uses this information to track when the last time a Tag communicated with a Gateway. In one embodiment, when a predetermined period of time has passed and no Gateway in the system has received a communication from the Gateway, the Tag may be marked on the Inventory Server as being away or absent. The person skilled in the art will appreciate that when the Tags are attached to inventory items to be tracked within a warehouse, the presence or absence of an inventory item may be tracked by checking the last time the Tag communicated with a Gateway. The system may be configured such that there is a predetermined time period in which all tags are guaranteed to have communicated with the Gateway at least once. If the predetermined timed period has elapsed and a Tag has not communicated with a Gateway, then the Tag is no longer proximate to any of the Gateways in the system.

In one embodiment, the communication protocol is unidirectional in the sense that information is broadcast from the Gateway to the Tags, and from the Tags back to the Gateway with no requirement for handshaking or request/response communication between Tags and Gateways. More specifically, there is no need for a receiving device to confirm receipt of a signal transmitted by a sending device by responding to that signal as all communications have a 100% transmission success rate. In an embodiment, the Gateway broadcasts a beacon signal to the Tags and, in response, the Tags broadcast data packets to the Gateway. The beacon signal sent from the Gateways to the Tags is then used inform the Gateways as to whether the Tags are proximate to the Gateway, as an example, whether they are inside a warehouse. The Beacon signal enables the Tags to broadcast their data payload (data packets). If Tags are able to receive a Gateway beacon signal, then they are relatively proximate to the Gateway, as an example, they are in the same warehouse as the Gateway. Once a beacon signal is received, Tags may start broadcasting their payload of data (data packets). If the Tags are not able to receive the Gateway beacon signal, then they are not proximate to the Gateway, meaning, for example, that they are outside the warehouse or not on site. In this case the Tags do not broadcast a data payload (data packets).

In another embodiment, information may be unicast or multicast by the Tags and Gateways. The particular configuration will depend on the requirements of the system being implemented. In this embodiment, information will still be transmitted “unidirectionally” in the sense that there is no requirement for handshake or request/response communication between the Tags and the Gateways.

The communication protocol utilized by the system is media independent and may be implemented within a wired or wireless system. For a wireless system, the protocol may be implemented on a standard radio frequency band centred at 2.4 GHz or 5 GHz, but may also be implemented on any other suitable radio frequency band. Although the description primarily discloses an embodiment of the invention that utilizes a digital transmission of packets, the protocol is mode independent and other transmission modes may be used, such as analog transmission.

As described above, in one embodiment of the present invention, Gateways are configured to broadcast beacon signals to a plurality of Tags. In one embodiment, beacon signals are sent at random intervals. The Gateways are further configured to receive data packets from Tags. In this manner, the Gateways are capable of receiving packets from the Tags, for example, for tracking purposes. As noted above, in one embodiment, the Gateways are able to determine whether the inventory, to which a Tag is attached, is proximate to the broadcasting Gateway.

In one embodiment of the present invention, Tags are configured to “sleep” for random periods of time. This “sleep” mode is a mode wherein most processes running within the Tag are shut down and the only requirement is a timer to trigger the Tag to “wake” at a random time. Configuring the Tags to sleep allows for battery power to be saved. The amount of time that a Tag sleeps for is configured depending on the requirements of the system.

When the internal timer triggers, the Tag “wakes” and utilizes full power. Upon waking the Tag is configured to momentarily listen for a beacon signal from a Gateway. If no beacon signal is received during the waking period, the Tag goes back into sleep mode for another randomized period of time. However, if a beacon signal is received, the Tag is configured to transmit a message in response. The message is packetized and broadcast or otherwise transmitted back to the Gateways. In one embodiment, a frequency on which the transmission takes place is chosen randomly from a set of frequencies. In this embodiment, the packets are transmitted on the randomly chosen frequency. Randomizing when each Tag wakes up and randomizing the frequency across which packets are transmitted reduces the chances that a collision with other transmissions from other Tags or other Gateways.

The process of the invention is continuous and allows messages from all Tags to be eventually be received by one or more Gateways within a predetermined time period. The amount of time needed for communications from all Tags to be received by one or more Gateways will depend on the specific configuration of the system.

In one embodiment of the present invention provided is a method of communication between at least one remote device and at least one central device. The method comprises determining at the at least one remote device a random amount of sleep time and causing the at least one remote device to enter a sleep mode for the random amount of sleep time. The at least one remote device is then caused to enter a power-on mode after the random amount period of sleep time has elapsed. The at least one remote device is then caused to listen, while in the power-on mode, to identify whether a beacon message was sent from at least one central device. Upon detecting at the at least one remote device a beacon message from the at least one central device, the at least one remote device is caused to transmit a response message and to return to sleep mode. Upon failing to detect at the at least one remote device the beacon message from the at least one central device, causing the at least one remote device to return to the sleep mode.

In a further embodiment of the present invention provided is a method of communication between a central device and a plurality of remote devices. The method comprises causing the central device to wait a random amount of time and causing the central device to transmit a beacon signal to the plurality of remote devices. The central device is then caused to receive a response message from at least one of the plurality of remote devices. At a randomized interval and on a randomized frequency the central device is caused to selected from a number of frequencies to which the central device may tune. Upon receiving a signal from a remote device, the central device is caused to process the data from within the signal.

In a further embodiment of the present invention provided is a system for communications between a plurality of remote devices and at least one central device, comprising at least one central device configured to periodically transmit beacon messages; receive response messages from the plurality of remote devices; process data from the received messages. Provided also are a plurality of remote devices having receivers, each configured to: enter a sleep mode for a random period of time; power-on the receiver after the random period of time has elapsed; listen for a predetermined period of time to detect receipt of a beacon message; upon receipt of the beacon message, transmit a response message and return to sleep mode; upon expiry of the predetermined period of time, return to sleep mode.

In a further embodiment of the present invention the at least one remote device, upon failing to detect the beacon message from the at least one central device, transmits a response message before returning to sleep mode.

In a further embodiment of the present invention the at least one remote device randomly selects a frequency on which to transmit its response message.

In a further embodiment of the present invention the steps repeated until each of the at least one remote devices have successfully transmitted a response message to one of the at least one central devices.

In a further embodiment of the present invention the beacon messages are broadcast.

In an even further embodiment the response messages are broadcast.

### BRIEF DESCRIPTION OF THE DRAWINGS

The following drawings illustrate examples of various components of the invention disclosed herein and are for illustrative purposes only. Other embodiments that are substantially similar can use other components that have a difference appearance.

FIG. 1 is a schematic diagram of an embodiment of the present invention.

FIG. 2 is a data transmission timing diagram corresponding to an embodiment of the present invention.

FIG. 2A is schematic diagram of an embodiment of the present invention.

FIG. 3 is a schematic diagram of the circuitry for a central device.

FIG. 4 is a schematic diagram of the circuitry for a remote device.

FIG. 5 is an illustration of a transmission sequence for a remote device.

FIG. 6 is an illustration of the structure of a packet for a beacon signal.

FIG. 7 is an illustration of the structure of a packet for a remote device ID.

FIG. 8 is an illustration of a beacon broadcasting structure.

FIG. 9 is an illustration of a remote device broadcasting structure.

FIG. 10 is a schematic diagram of a system employing one central device and multiple remote devices.

FIG. 11 is a schematic diagram of a system employing multiple central devices and multiple remote devices.

FIG. 12 is a flowchart of a method of the present invention.

FIG. 12A is a flowchart of a method of the present invention.

FIG. 13 is a flowchart of a method of the present invention.

FIG. 14 is a graph depicting packet collision rate results for certain system parameters for an example system in line with the present invention.

FIG. 15 is a schematic diagram showing how Remote Devices physical location can be determined, using several Central Devices.

FIG. 16 is an illustration of the Remote Device data packet structure containing information for physical location.

FIG. 17 is a schematic diagram showing a Central Devices structure used for system having a huge number of Remote Devices.

FIG. 18 is a schematic diagram showing a Central Device with multiple TX modules.

FIG. 19 is a schematic showing a system that includes a GATEWAY-Server for Remote Devices information capture, storage and process to be ready for the Inventory System to be retrieved.

FIG. 20 is a schematic showing Central Devices communication between them.

### DETAILED DESCRIPTION

The present invention overcomes the limitations of the prior art by providing a new and more effective communication protocol.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

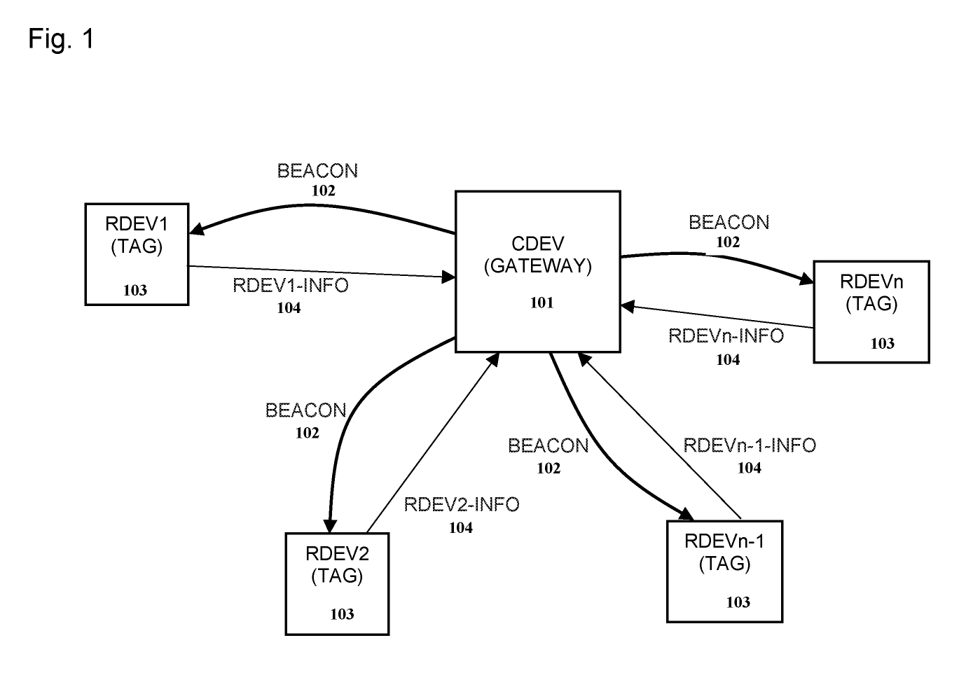

Referring now to FIG. 1, shown is an example consisting of one Gateway (CDEV) 101 and many Tags (RDEVs) 103. The Tags 103 range in number from 1 to n, where n is the maximum number of Tags 103 that may be supported by a Gateway 101. In one embodiment, a beacon signal 102 is broadcasted from a transmitter (Tx) 104 module present on Gateway 101 at a random rate. The beacon signal 102 that is broadcast by a Gateway 101 enables a receiving Tag 103 to broadcast its payload of data (data packets) back to the Gateway 101.

Due to the random nature of the system, as will be described in further detail below, the system allows for packet collisions during the transmission 104 of data payloads on the assumption that a retransmission 104 at some random future time will be successful. Packet collisions are acceptable for several reasons. First, a packet sent from one Tag 103 may be received by many Gateways 101 at the same time, depending on how the system's topology is implemented. Multiple received packets may then filtered when the data received is processed. Second, it is assumed that the Tag 103 will continue periodically waking up to determine whether it ought to send a transmission 104 in response to a beacon signal. In this way, the system is designed such that even if there is a transmission 104 by a Tag 103 that collides with a transmission from another Tag 103 or Gateway 102, it will eventually “randomly” wake up to transmit and not collide with another transmission 104.

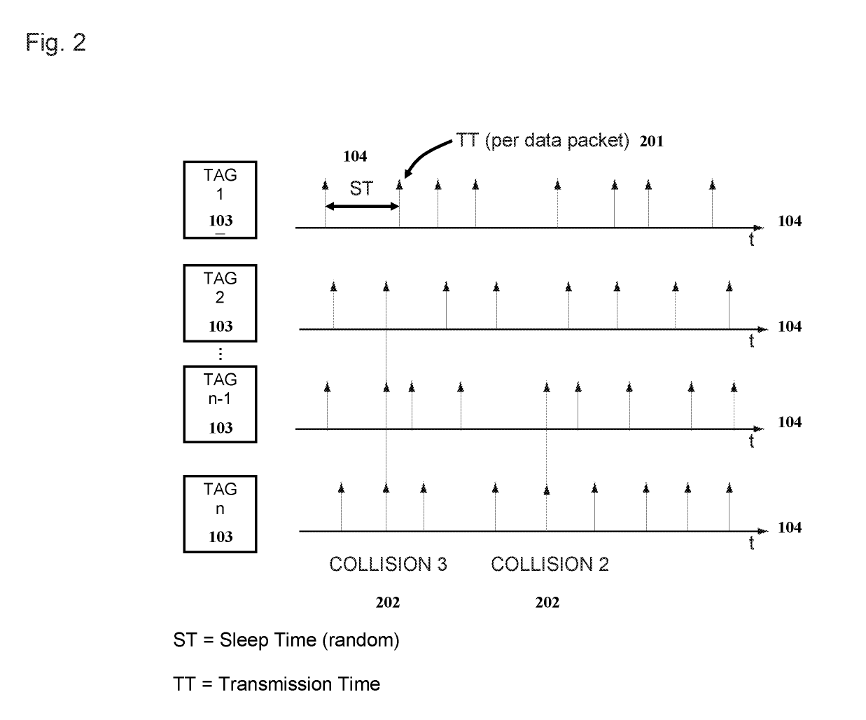

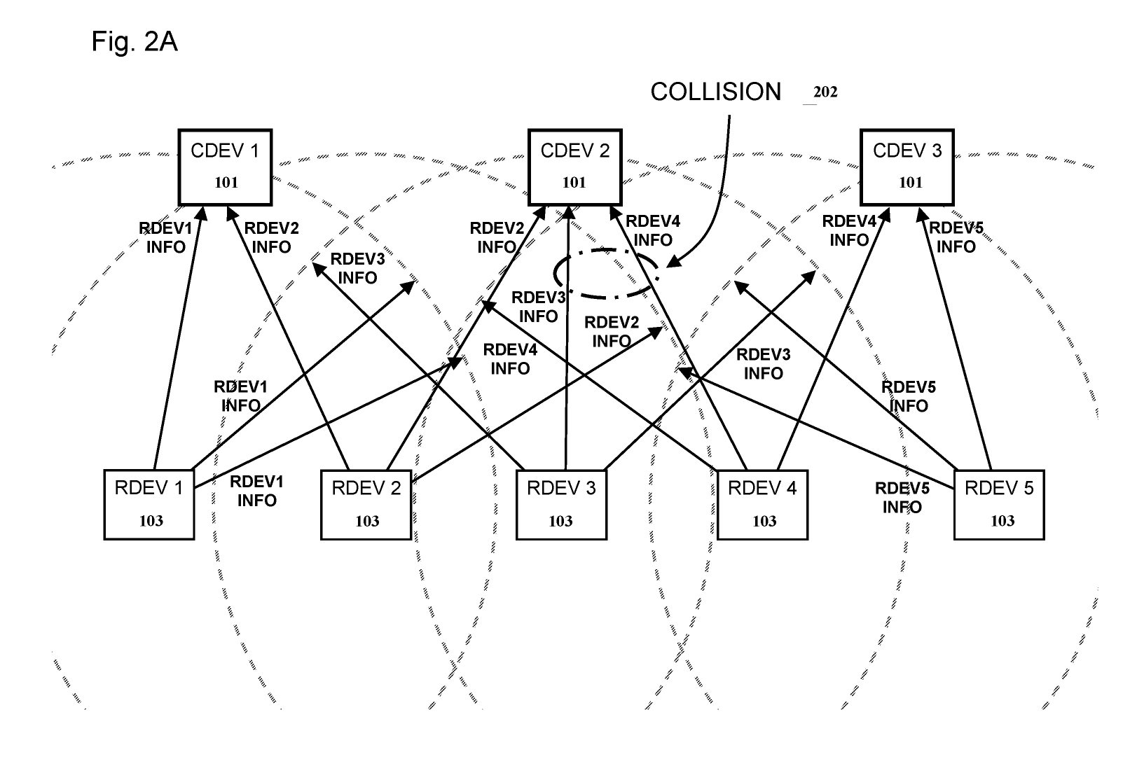

Referring now to FIG. 2, shown is a timing diagram illustrating packet collisions in an embodiment of the current system. Each Tag (RDEV) 103 transmits 104 a data packet 201 to the Gateway (CDEV) 101, on a randomly assigned frequency. If there are only a few frequencies to which a Tag 103 may transmit 104 and if there are a large number of Tags 103 are deployed, there may be a high probability that the same frequency will be selected for transmission 104 by multiple Tags 103. When the same frequencies are selected, and when the transmissions 104 are sent at the same time, collisions 202 occur and packets 201 are lost. However, such packet 201 loss is contemplated and accounted for in the current system as Tags 103. Specifically, Tags 103 may broadcast their packets 201 multiple times at different times and on different frequencies and, overall, achieve transmission 104 despite the collisions 202.

Referring now to FIG. 2A, shown are three Gateways (CDEVs) 101 and five Tags (RDEVs) 103. Due to the physical topology and antenna distribution for the example system illustrated in FIG. 2A, every Tag 103 is able to reach one or more of the Gateways 101 with its broadcast signal, but potentially not every Gateway 101. For example, Tag 103 RDEV 1 may only reach CDEV1 101, Tags 103 RDEV 2 may only reach CDEV1 101 and CDEV2 101. The dotted lines illustrate a hypothetical limited range that a Tag's 103 response transmission 104 will reach.

For the example illustrated in FIG. 2A, if data packets 201 transmitted from Tag 103 RDEV 3 and Tag 103 RDEV 4 collide 202, the packet 201 transmitted 104 from Tag 103 RDEV 3 may be lost at this time but the data packet 201 transmitted 104 from Tag 103 RDEV 4 may be received by CDEV3. In the next time cycle, when Tag 103 RDEV 3 is powered on and receives a beacon signal 102, it will broadcast its data packet 102, at which point the packet may be received by CDEV2.

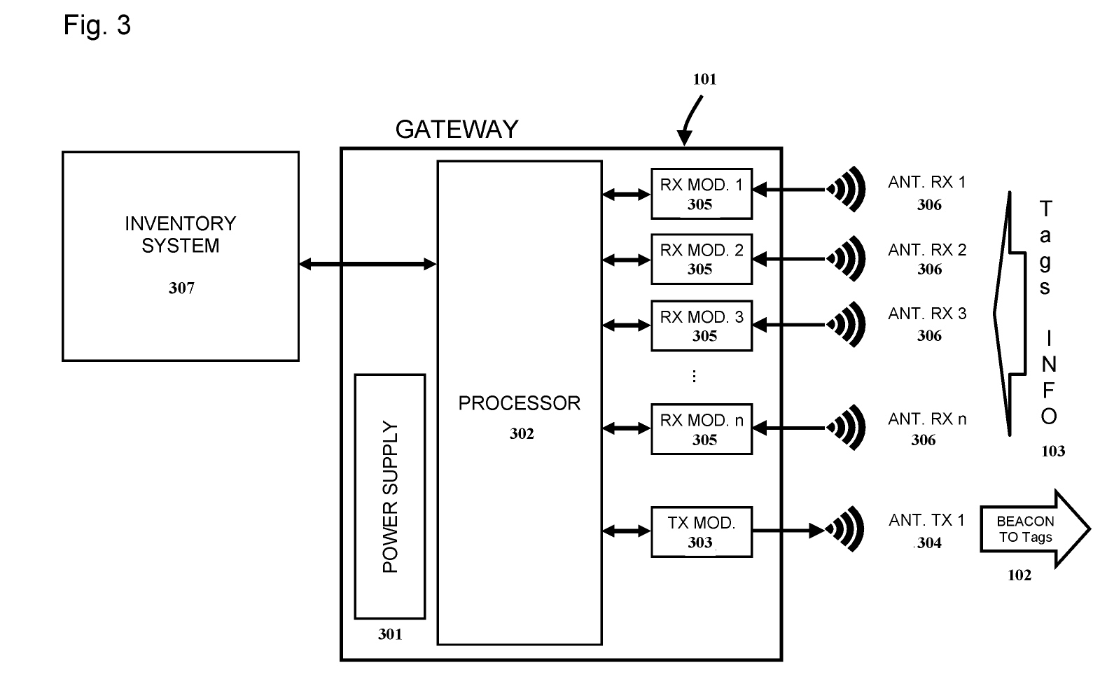

Referring to FIG. 3, shown is one embodiment of a CDEV or Gateway 101 of the present invention. The Gateway 101 is powered by a power supply unit 301, and processes data by way of a processor 302. Using a transmitter (Tx) module 303 and antenna 304 the Gateway 101 is capable of broadcasting a beacon 102 to the Tags 103. Receiver modules (Rx) 305 are also present on the Gateway 101 and are coupled with antennas 306 to receive data packets 201 that comprise a data payload, which are transmitted 104 from Tags 103.

Gateway 101 may have more than one receiver (Rx) module 305 comprising more than one tuner (not shown). This allows the Gateway 101 to received signals broadcast on multiple channels or frequencies simultaneously. Alternatively, Gateway 101 may include a single receiver module 305 with programming or hardware capable of extracting multiple data streams from one signal. The specific number of receiver modules 305 may be defined for each specific application. The purpose of each receiver module 305 is to listen for incoming transmissions 104 comprising data packets 201 transmitted by Tags 103. Each receiver module 305 may be tuned to a different frequency channel for receiving data packets 201 that are transmitted 104 at different frequencies. In one embodiment, the frequency at which a given Tag 103 transmits 104 is randomly (or pseudo randomly) selected in order to reduce the likelihood of collisions 202.

Gateway 101 may be connected to an Inventory System 307. In scenarios where multiple Gateways 101 are used, an Inventory Server 307 receives data from each of the Gateways 101 so that further processing 302 of the data can take place. The Inventory Server 307 may track which Tags 103 have successfully communicated with the Gateways 101 within a predetermined time period to determine whether a Tag 103 is present in the system or not. The predetermined time period is set in accordance with an estimated time in which all Tags 103 present within a particular physical location (e.g., a warehouse) are expected to have successfully transmitted 104 with one or more Gateways 101.

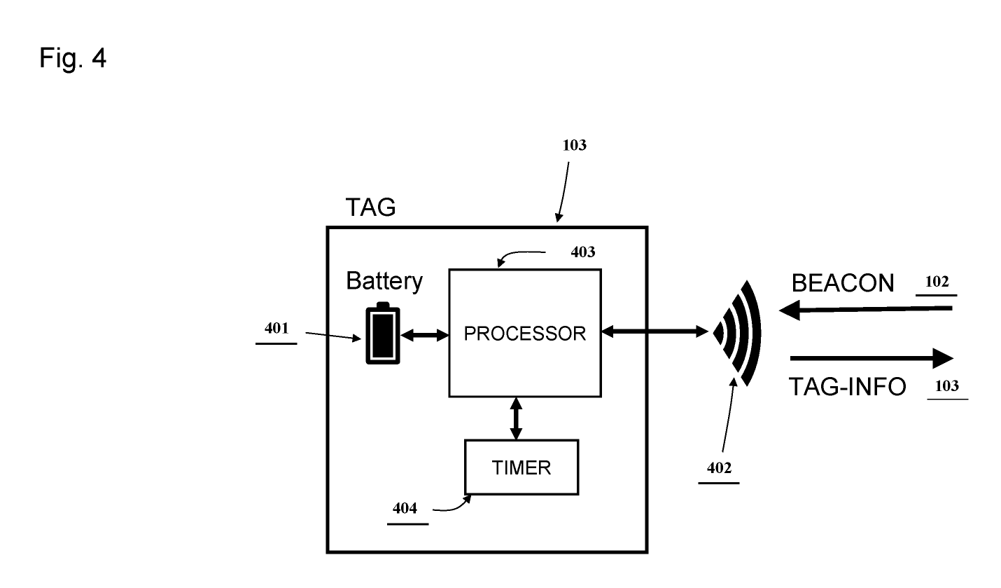

Referring to FIG. 4, shown is one embodiment of a RDEV, or Tag 103, of the present invention. The Tag 103 is powered by batteries 401. Each Tag 103 typically has a transceiver 402, which is configured to receive a beacon 102 signal from a Gateway 101 and broadcast a data payload in the form of data packets 201 back to at least one Gateway 101. The transceiver 402 is capable of being powered on or powered off. For example, transceiver 402 is powered off when the Tag 103 enters “sleep mode”. Tag 103 comprises a processor 403 for sending commands to power on and power off the transceiver 402. Minimal battery 401 power is needed for processor 403 to maintain a timer 404 and also computer code which determines when the transceiver 402 wakes up.

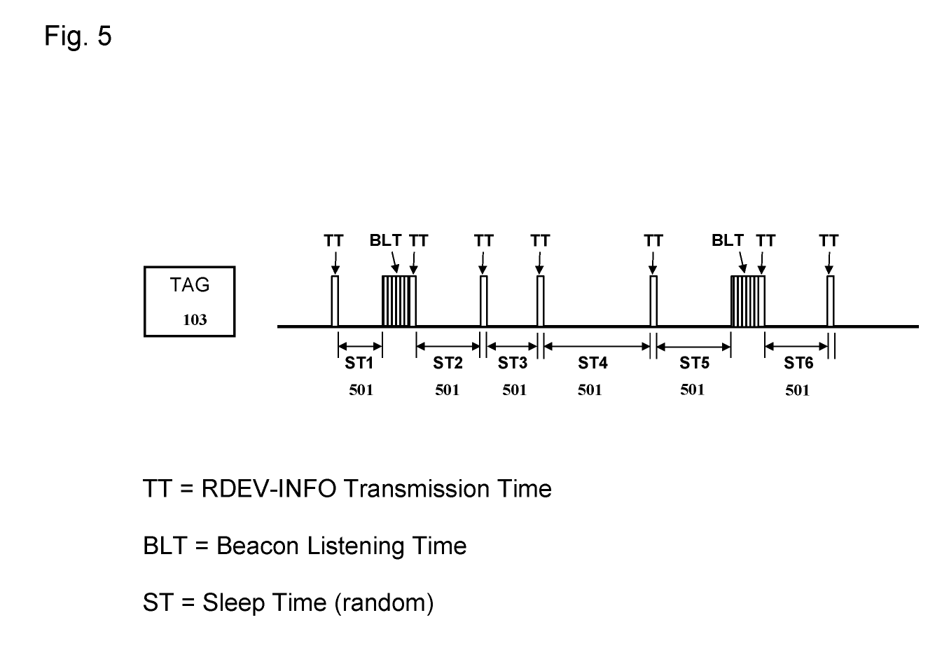

Referring to FIG. 5 depicted is a timing diagram illustrating how the sleep mode works on a particular Tag 103, showing graphically when the Tag 103 sleeps and when it wakes up (powers on). ST1, ST2, ST3, ST4, and ST5 are the “sleep times” 501 randomly selected by the processor of each Tag 103. In the embodiment shown, the amount of transmission 104 time is brief relative to the amount of time that the device is in sleep mode.

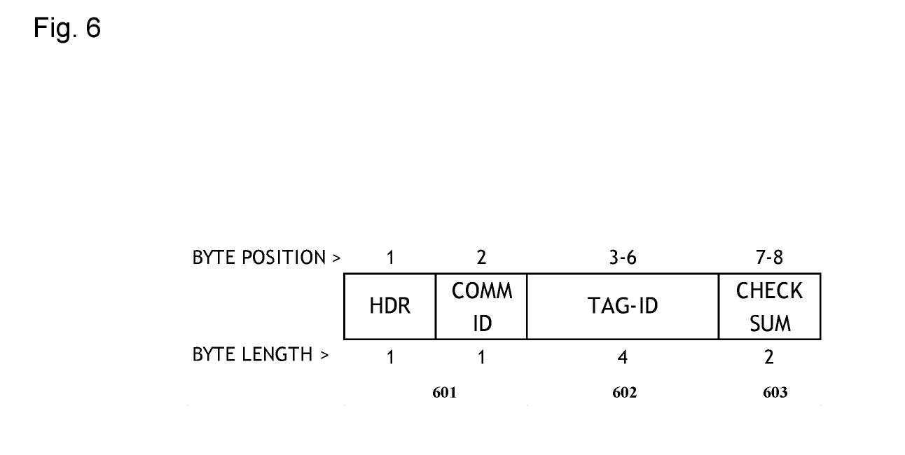

Referring now to FIG. 6, shown is an illustration of an exemplary data packet 201 structure for a beacon signal 102 for an embodiment of the present invention. The packet 201 includes a predetermined prefix 601, which may be encoded on 2 or more bytes (B1 and B2). This prefix may also contain functional parameters, configuration parameters, and/or other information. Examples of such parameters or information include: what range of channels a Tag 103 may broadcast its data packets 201, sleep time 501 min and max and other parameters useful for all the Tags 103. The person skilled in the art will appreciate that other parameters or information may be provided in the beacon signal 501 depending on the requirements of the particular application.

Following the predetermined information 601, the packet may comprise specific beacon identification 602 information encoded, for example, in 4 bytes. This is used to provided identification information as to which beacon 102 sent the information. This identification information may be used by Tags 103 to unicast or multicast transmissions 104 back to back to the Gateway 101 which originated the beacon 102. However, this is not required and in some embodiments, transmission 104 from Tags 103 are broadcast to any device in range. Finally, the beacon 102 packet 201 ends with a checksum 603 for error correction, which may be encoded on 2 bytes. However, it will be apparent to the skilled person that other packet 201 configurations are possible.

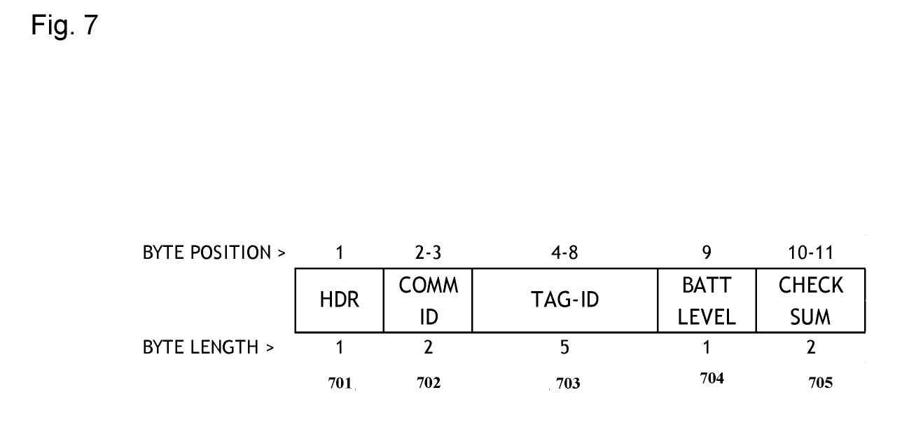

Referring to FIG. 7, shown is an illustration of an exemplary structure of a packet 201 for a remote device or Tag 103, which may be sent by a Tag 103 in an embodiment of the present invention. The packet 201 structure begins with a communication ID 701 byte and a number of bytes indicating the length of the packet 201. After the communication ID 701 and communication length 702 comes the TP-ID 703, which is specific and unique to each Tag 103. The TP-ID 703 is the information that allows the Gateway 101 to keep a track of Tag 101 status and whether the Tag 103 is within range of a particular Gateway 101.

Following the TP-ID 703 is a byte which encodes the battery level 704 of the specific broadcasting Tag 103 and a cyclic redundancy check 705, for error checking. The byte for tracking battery level 704 may be processed by a Gateway 101 or an Inventory Server 307 to alert the system that the battery 401 on a Tag 103 may need to be recharged or replaced. It will be apparent to the skilled person that this packet 201 structure is exemplary and may be modified without departing form the scope of the present invention.

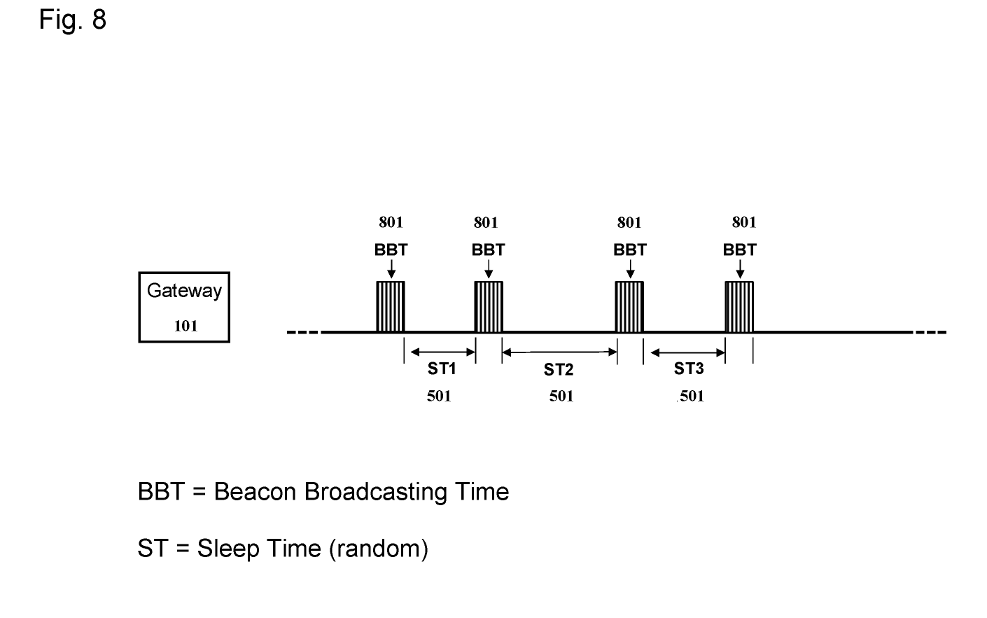

Referring to FIG. 8, shown is an illustration depicting a transmission 104 sequence from the perspective of the Gateway 101. The beacon 102 broadcast time 801 is broadcast for a predetermined interval, which is required to transmit 104 a beacon 102 packet 201. In one example the time required to transmit 104 the beacon 102 broadcast time 801 may be 1 ms. However, this time may vary depending on the technology available, the frequencies used, and the amount of information included in the beacon 102 broadcast time 801. The broadcast 801 may then stop for a random amount of sleep time 501. In this example, the sleep time can range from 50 to 200 milliseconds. After the sleep time, the beacon 102 signal is again broadcasted. The cycle repeats indefinitely. In this example the beacon 102 is broadcasted, but the beacon 102 signal may also be transmitted 104 via unicast or multicast.

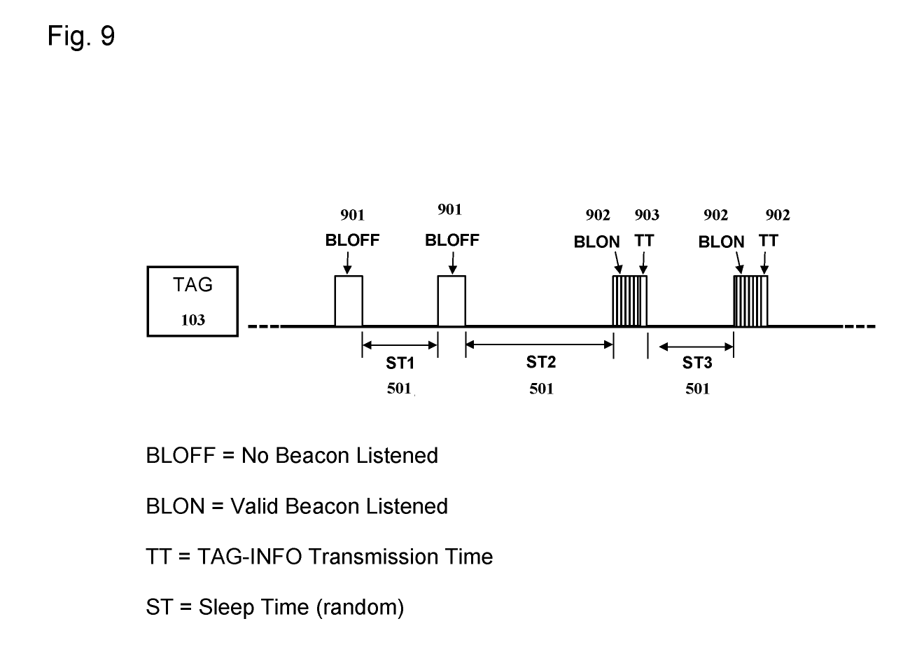

Referring to FIG. 9, shown is an illustration of a transmission 104 sequence from the perspective of a Tag 103. FIG. 9 illustrates the overlap between the beacon 102 broadcast and the Tag 103 packet 201 broadcast. In the illustrated example, a Tag 103 is configured to “sleep” for a random period of time 501. After the random period of time elapses, the Tag 103 is configured to “wake” up, or power on. Once powered on, a Tag 103 will listen for a beacon 102 signal for a predetermined period of time 901. In this example, a Tag 103 may potentially listen for 150 ms, after which a time out is triggered in the case that a beacon 103 signal is not present, or a beacon 103 signal is received. If no beacon 103 signal is received in the randomized 150 ms listening window, the Tag 103 will re-enter “sleep” mode 501 for another random length of time. After sleep time 501 the Tag 103 “wakes” up again and listens. If a beacon 102 signal is received when a Tag 103 is in a listening window, the Tag 103 is configured to broadcast information to the available Gateways 101 in its neighbourhood of proximity. All the available Gateways 101 proximate to a Tag 103 will receive that Tag's 103 broadcasted Tag 103 data packet 201 and TP-ID 703. Prior to broadcasting, the Tag 103 randomly chooses a frequency on which to broadcast its data. This frequency is chosen from those available to the receiving modules at the Gateway 101. In this example the Tag 103 broadcasts it's response message. However, the response message may also be transmitted 104 via unicast or multicast.

In a further embodiment, a Tag 103 may or may not broadcast its data 201 to the Gateways 101 depending on the information contained in the beacon signal 102. For example, beacon signal 102 may be unicast to a single Tag 103 or multicast to a subset of all Tags 103 that are intended to receive the message. Only those Tags 103 to which the beacon signal 102 is sent respond to that message.

In another embodiment, the beacon signal 102 is sent from the Gateway 101 to let the Tags 103 know that they are “close” or “in range” such that data packets may be sent by the Tags 103 to the Gateway 101.

The data 201 sent by a Tag 103 on a specific and randomly chosen frequency is received by the receiver module on a Gateway 101 that is tuned to that frequency. The received Tag 103 packet 201 may be processed, filtered, and analyzed by the Gateway 101. Data 201 received by the Gateway 101 may further be stored, retransmitted 104, and/or analyzed. Other processes or processing may also be carried out on the data 201 by a Gateway 101 as required in a specific implementation of the communication protocol. Also, the data 201 received by the Gateway 101 may be retransmitted 104 to an Inventory Server 307 for further processing.

In this manner, the Gateway 101 may randomly collect data 201 on Tags 103 deployed on inventory. The cycle of the Tag 103 “sleeping” for a random amount of time 501 and “waking up” to listen 902 the beacon signal 102 continues indefinitely, and even if the Tag 103 transmission time 903 for a particular system is reached and 100% transmission has occurred. The Tag 103 transmission time 903 is defined as the maximum time for all the Gateways 101 installed on a specific system to receive a specific TP-ID 703, from the time when the Tag 103 goes into the warehouse and it is “in range” of the beacon signal 102.

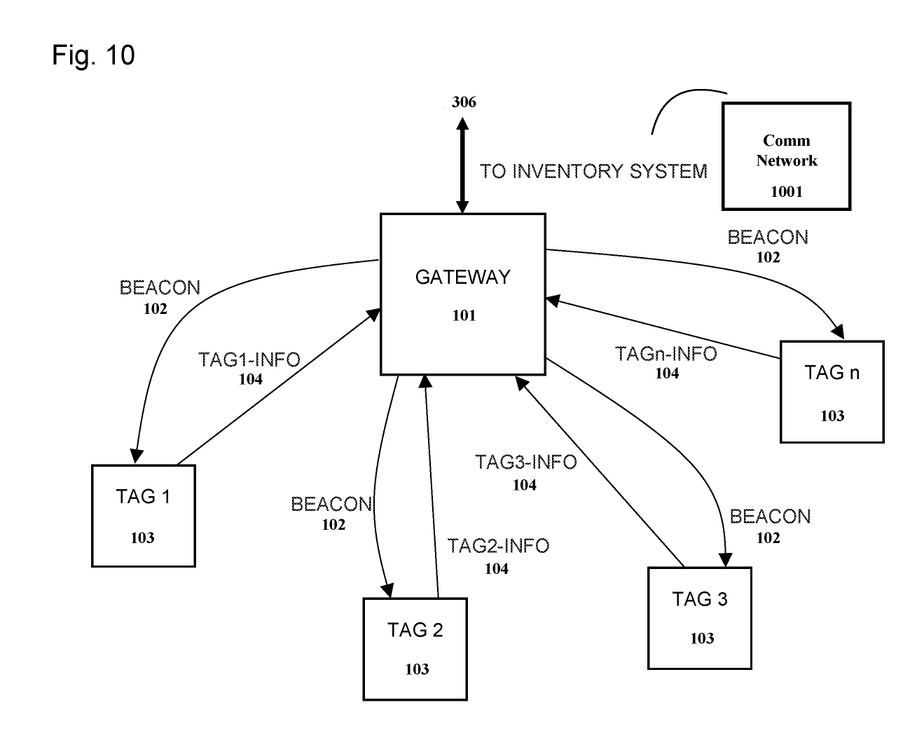

Referring to FIG. 10, shown is a schematic diagram of a system employing one central device and multiple remote devices, or Tags 103. The central device, or Gateway 101, sends out a beacon 102 in a manner similar to FIG. 8. As soon as the Tags 103 are “listening” for a beacon 102 signal they are enabled to broadcast their TP-ID 703 containing data packets 201 to the Gateway 101 on a randomize broadcast frequency. Data 201 received at the Gateway 101 may then sent from the Gateway 101 to an inventory system 307.

In a further embodiment of the present invention, each Gateway 101 may also be enabled to communicate by way of the communications network 1001 according to any suitable protocol compatible with an inventory system 307. Further, each Gateway 101 may be enabled to communicate in a wireless or wired manner, as may be required in a certain application, compatible with the communications network 1001, including but not limited to packet based communication protocols, Internet protocols, analog protocols, PSTN protocols, cellular protocols, WiFi protocols, WiMax protocols and any combination of protocols. Other protocols may also be used.

Communications network 1001 may also comprise a combination of wired or wireless networks, including but not limited to packet based networks, the Internet, analog networks, PSTN, LAN, WAN, cell phone networks, WiFi networks, WiMax networks and any combination of networks.

By way of the communications network 1001, each Gateway 101 may communicate the status of each Tag 103 to the inventory system 307 to keep track of the location and status of inventory. Alternatively, the Gateway 101 may transmit the received Tag 103 messages to the inventory system 307 for further processing. In this scenario, the inventory system 307 would process the received Tag 103 messages to determine the location and status of inventory.

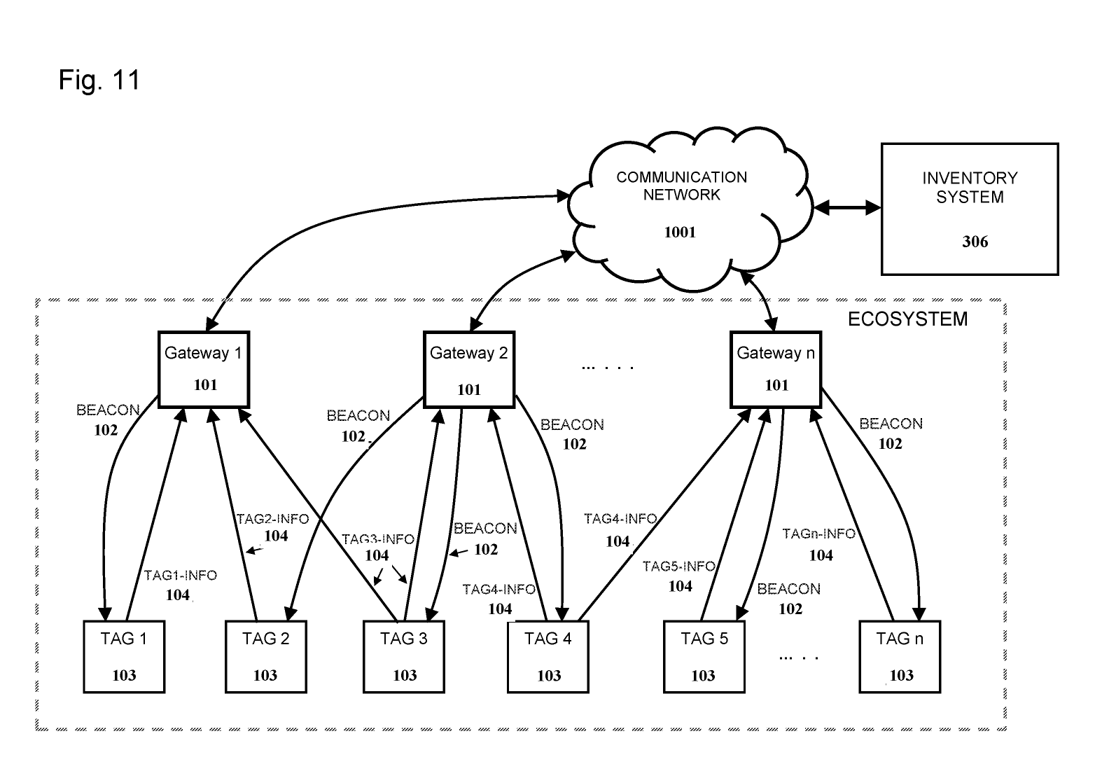

Referring to FIG. 11, shown is a schematic diagram of a system employing multiple central devices and multiple remote devices. In this example, three Gateways 101 broadcast beacon signals 102 out in the manner similar to FIG. 8. If the Tags 103 are “awake” and they are able to “listen” for a broadcast beacon signal 102, they can then broadcast their TP-ID 703 containing data packets 201 to the Gateways 101. In some situations, a Tag 103 receives, beacon signals 102 from multiple gateways 101, and if the Tags 103 are in the “awake” mode, a TP-ID 703 is broadcast to all the Gateways 101. Each Gateway 101 then transmits information about the Tags 103 from which they have received messages to the Inventory System 307 via a communication network 1001.

The Inventory System 307 may comprise a computer-based system for tracking inventory levels, orders, sales, deliveries, and any other information that the skilled person could require. In this manner, the Inventory System 307 may facilitate the tracking of inventory or assets as they move through a warehouse or storage depot. The system may produce a directory of inventory assets to provide information on exactly what is available and where.

In a further embodiment of the present invention, packet 201 collisions 202 may be further mitigated if Tags 103 are also configured to randomly send data back to the Gateway 101 more than once during a predetermined waking period, when a beacon signal 102 has been received.

One feature of the communication protocol is that there is no requirement to synchronize the beacon signal 102 from the Gateways 101 to the Tags 103 or to synchronize data packets 201 from Tags 103 to Gateways 101. In particular, there is no need to synchronize timing to avoid signal collisions 202. Instead, beacon signals 102 are broadcasted by Gateway 101 to Tags 103 and vice versa based on random “sleep” timing 501 and a randomly selected frequency channel, and is intended to be transmitted 104 (or broadcast) more than once. By setting timing parameters and frequency parameters appropriately transmission 104 from Gateway 101 to Tag 103 or from Tag 103 to Gateway 101 may be statistically guaranteed for a given time period.

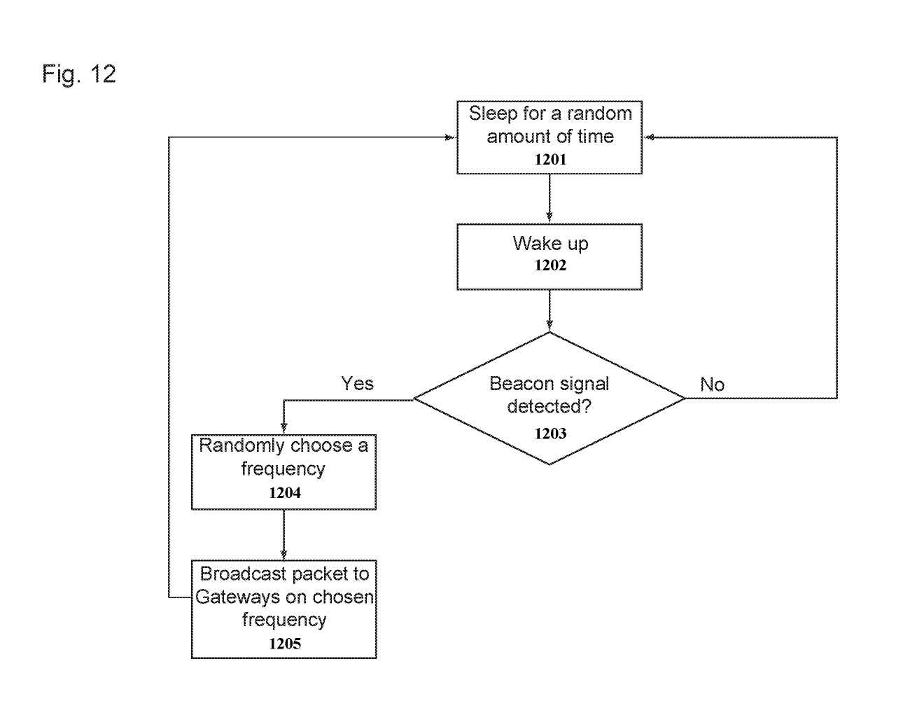

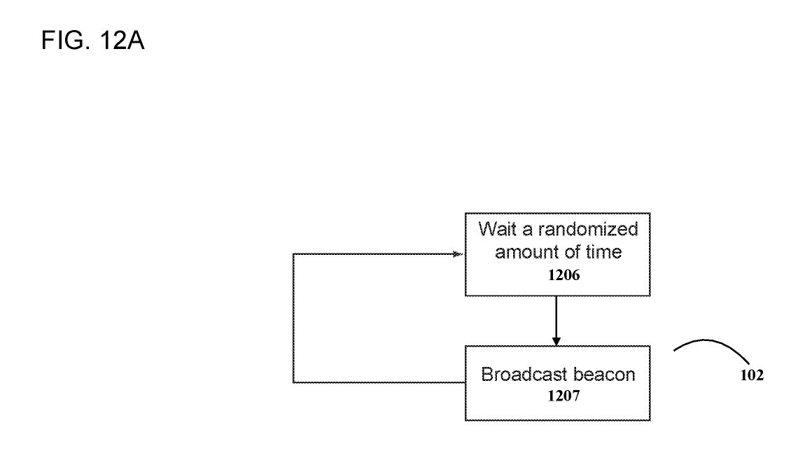

Referring to FIG. 12, shown is an exemplary method for how a Tag 103 communicates with a Gateway 101 or multiple Gateways 101. The method comprises a first step of causing the Tag 101 to enter a sleep mode for a randomized period of time 1201. After a randomized period of time 1201, the Tag 103 is caused to exit sleep mode to enter a power-on or “waking” mode 1202 and further to listen if a beacon signal 102 is broadcast from any proximal Gateway 101. If a beacon signal 102 has been detected 1203, the Tag 103 is caused to randomly select a frequency 1204 on which a data packet 201 is broadcasted 1205 to the available Gateways 101. Broadcasting 1205 the signal to the available Gateways 101 causes the Tag 103 to return to sleep mode 1201 and begin the cycle again. If no beacon signal is detected 1203, the Tag 103 returns to the sleep mode 1201 and begins the cycle again.

In another embodiment of the present invention, Tags 103 may also broadcast 1205 their data packets 201 without first detecting 1203 a beacon signal or ever listening for one. In such an embodiment, a Tag 103 may also be programmed to send its data 201 after a predetermined number of times the Tag 103 has entered “wake” mode. For example, a Tag 103 may leave sleep mode and enter wake mode 1202 three separate times and never detect 1203 a beacon single. In such a case, the Tag 103 may be programmed to nevertheless send its data.

Referring to FIG. 12A, shown is an exemplary method of how at least one Gateway 101 broadcasts a beacon signal 102 to one or more deployed Tags 103. The method, consists of the steps for causing the Gateway 101 to wait a random period of time 1206 and the causing the Gateway 101 to broadcast 1207 a beacon signal 102 to the Tags 103. This cycle to repeats indefinitely and until the beacon signal 102 is shut down by a system manager for maintenance, testing or other purposes. Alternatively, the beacon signal 102 may be transmitted 104 after a predetermined sleep period 501 which is not random.

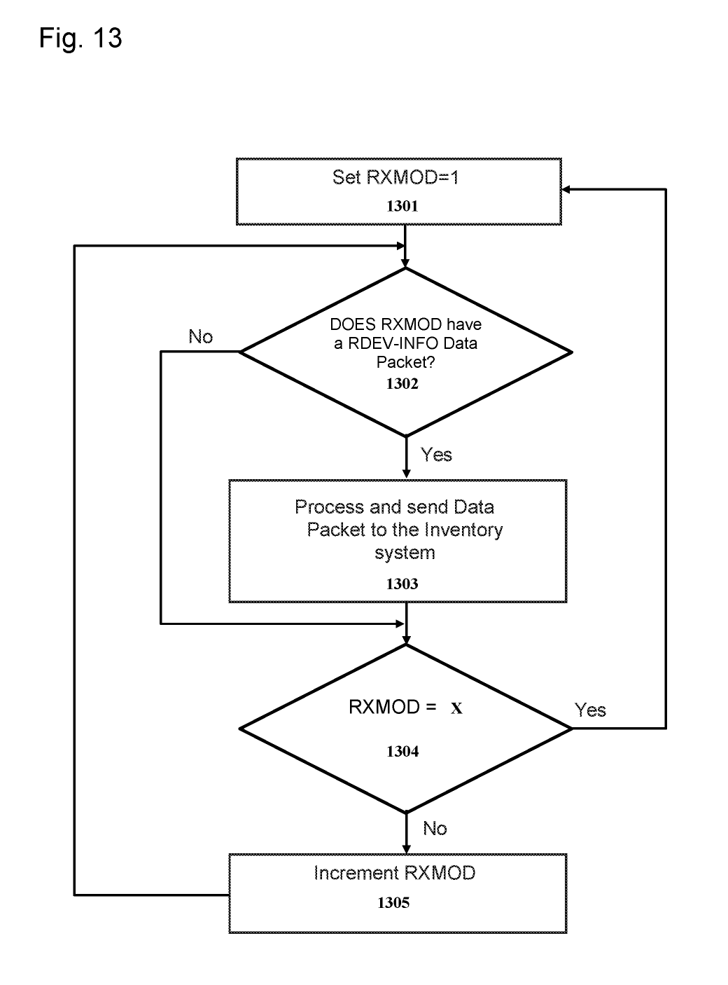

Referring to FIG. 13, shown is an exemplary method of how at least one Gateway 101 with at least 6 receiver modules determines if it has received data 201 transmitted 104 from at least one Tag 103. A viewer may perceive that at least one Gateway 101 sets the channel 1301 which it will poll to 1. It is then determined 1302 whether data 201 has been received by the Rx module 305 tuned to the first channel (not shown). If data 201 has been received on the first channel, the Gateway 101 proceeds to process 1303 the data packet 201 that was received on that channel. The information from the processed 1303 data packet 201 is then sent to the inventory server 307 and tracking of the corresponding Tag 103 is completed. If no data 201 has been received on the first channel, or if the data 201 on the first channel has been processed 203, the Gateway 101 checks if it has polled 1304 each of its available channels/receiver modules. If each of the available channels/receiver modules have been polled 1304 then the system returns to the first channel and begins the process anew. If the channels have not been polled 1304, the Gateway 101 increments 1305 the channel count and checks the Rx module 305 corresponding to the channel count for received data 201. This cycle continues indefinitely. In an alternative embodiment, the Gateway 101 is capable of monitoring more than one channel. In yet a further embodiment, the Gateway 101 is capable of monitoring all available channels.

Certain parameters are used to define, make-up and configure the system, and may be defined as follows: NTAG [integer] is the number of Tags 103 per Gateway 101 for a specific system configuration. For worst case calculation purposes, this value is taken from the Gateway 101 that has the most number of Tags 103 associated with it. ST[seconds] is the sleep time 501 in seconds, which is randomly calculated between two values: Sleep Time 501 minimum (STmin) and Sleep Time 501 maximum (STmax), by every Tag 103 on every cycle. The sleep time 501 can vary between 0 and a maximum value. STmin [seconds] is the minimum Sleep Time 501 allowed for a Tag 103 to sleep. STmax [seconds] is the maximum Sleep Time 501 allowed for a Tag to sleep. STavg [seconds] is the average Sleep Time 501 defined for a given implementations of the system and is calculated as: STavg=(STmin+STmax)/2. STQ [integer] is the quotient of factor between STmax and STavg and is calculated using the equation: STQ=STmax/STavg. TT[seconds] is the transmission 104 time in seconds and represents the time required for a Tag 103 to broadcast a data packet 201. Transmission 104 time depends on the available technology. NDP[integer] is the number of times the same Data Packet 201 is broadcasted every time the Tag 103 wakes up that can be configured for any Tag 103 Ecosystem. The NDP selection depends on the specific Tag 103 Ecosystem requirements and takes into account certain systemic variables such as noise in the environment where the system is deployed, interference amongst signals, or a signal bouncing among other signals. NRX[integer] is the number of Rx modules 305, or channels, that are available to each Gateway 101 and with which the Gateway 101 may randomly receiving a broadcast data payload or data packet 201 from the Tags 103. TAGQ [integer] is a quotient or factor between the number of Tags 103 per Gateway 101 and the Sleep Time 501 maximum value for a given system. This parameter is calculated using the following equation: TAGQ=NTAG/STmax. DPCOL [percentage] is the percentage of broadcast data payloads or data packet 201 lost or not received by the Gateway. It can be calculated using the following equation: DPCOL=DPLOST/DP TOTAL Where: DPLOST is the total amount of collided data packets 201 broadcast by the NTAG and DP TOTAL is the total amount of data packets 201 sent by the NTAG.

A simulation of a system may be constructed by a skilled person in the art to evaluate the parameters of the system that are suitable to a particular Tag 103 Ecosystem that will be deployed. The simulation may be constructed using computational software or may be made up of computer readable code which may be executed on a computing device.

The first step in defining such a simulation is to define the above listed parameters within the simulation. Namely, the parameters to be defined are: NTAG, STmax, STmin, TT, NDP, NRX. The purpose of the simulation is to calculate parameters values for STQ, TAGQ and DPCOL. A mathematical simulation may be created to emulate any potential system with any amount of Gateways 101 and any amount of Tags 103.

TDT is the average Tag Detection Time for a specific TAG PRO system. TDT is obtained empirically and can be measured according to the following formula: TDT=KTR×STₘₐₓ. KTR is empirically calculated from mathematic simulations or from real systems embodiments.

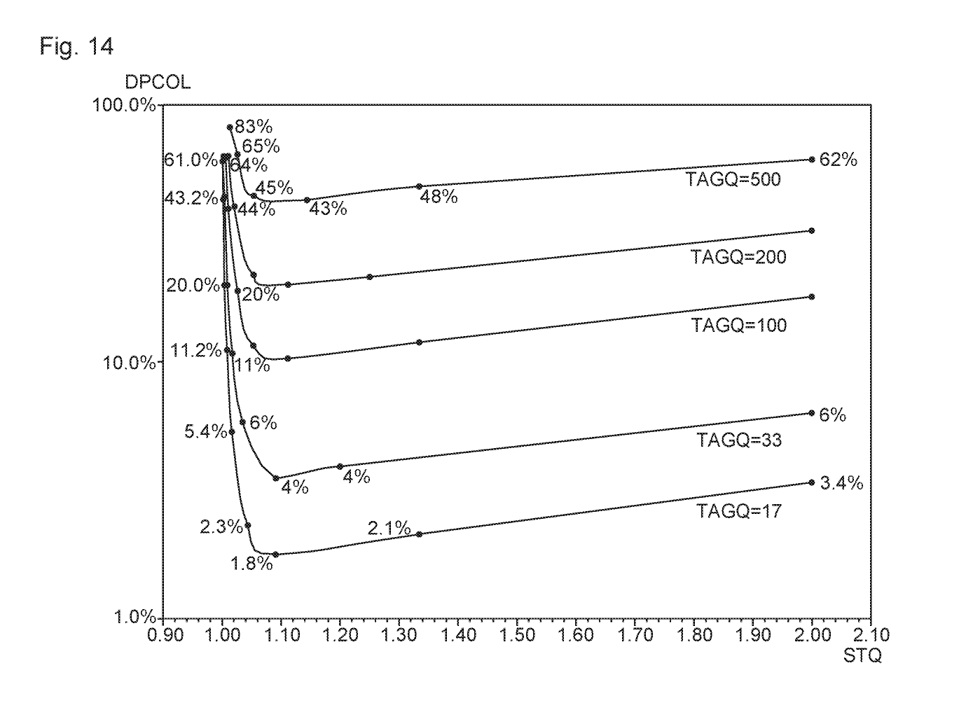

Referring to FIG. 14, a system may be built for a low density system having DPCOL under 5%, STQ about 1.1, TAGQ about 35, a KTR=2 to 3 can be expected. In this situation, and using for example STmax=300 seconds (5 minutes), the following parameter values are to be expected: NTAG=10,500 Tags 103 per Gateway 101 maximum and TDT between 10 to 15 minutes.

A system may also be build for a “medium” to “high” density system having DPCOL under 20%, STQ about 1.1, TAGQ about 100, a KTR=6 to 7 can be expected. In this situation, and using for example STmax=300 seconds (5 minutes), the following parameter values are to be expected: NTAG=30,000 Tags 103 per Gateway 101 and TDT between 30 to 35 minutes.

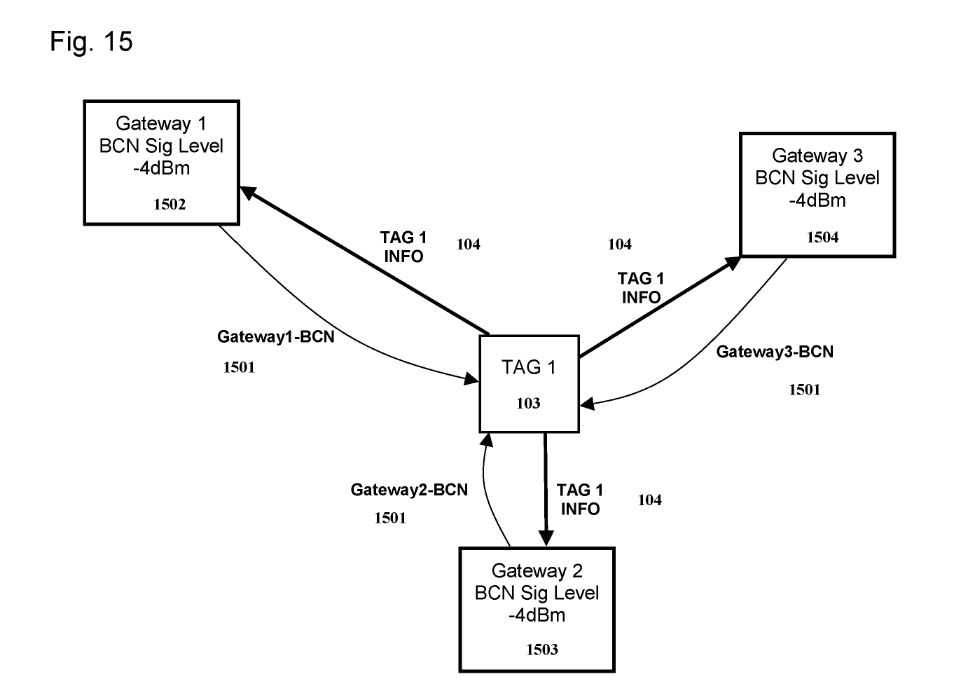

Referring to FIG. 15, it is an exemplary method showing how Tag 103 physical localization can be achieved on a specific Tag 103 Ecosystem (warehouse for example) by placing/installing the Gateways 101 associated with the Tag 103 Ecosystem real physical coordinates (x and y location inside the warehouse). In a preferred embodiment of the present invention, the Gateway 101 beacon signal 102 can incorporate a unique Gateway-ID 1501. During the beacon signal 102 detection 1203 process, Tags 103 receive and store at least two beacon signals 102 coming from different Gateways: Gateway-ID 1501 and RSSI (Received signal Strength Indicator). Tags 103 broadcast the Gateway-ID 1501 and RSSI together with its Tag 103 information 104 to the Gateways 101 so the Gateways 101 or a further processing software can determine the approximate physical Tag 103 location associating the Gateway-ID 1501 and RSSI with the Gateway 101 physical placement.

In a preferred embodiment of the present invention, the Gateways 101 beacon signal 102 are adjusted to specific values so Tags 103 approximate position inside of a specified location, even X, Y and Z, can be determined analyzing the Gateway ID 1501 and the RSSI strength received.

FIG. 15 shows an example with three Gateway beacon signals 1502, 1503, and 1504, and one Tag 103, where the Tag 103 is physically located closer to the first Gateway beacon signal 1502 than the other Gateway beacon signals 1503, 1504 and also located closer than the second Gateway beacon signal 1503 than the first Gateway beacon signal 1502. In such a configuration, the beacon signals on each Gateway 1502, 1503, 1504 is set at the same level. The Tag 103 listens for the third Gateway beacon signal 1504 at higher level (RSSI) than the first or second Gateway beason signals 1502, 1503, and the second Gateway beacon signal 1503 beacon signal level (RSSI) higher than the first Gateway beacon signal 1502. This information can be analyzed by a Software application located at the GATEWAY-Server, concluding where the Tag 103 can be placed inside the Tag 103 Ecosystem. In other embodiments, beacon signals on each Gateway 1502, 1503, 1504 can be set at different levels and the RSSI levels received by the Tags 103 from each Gateway 1501 can be equalized to get an accurate position.

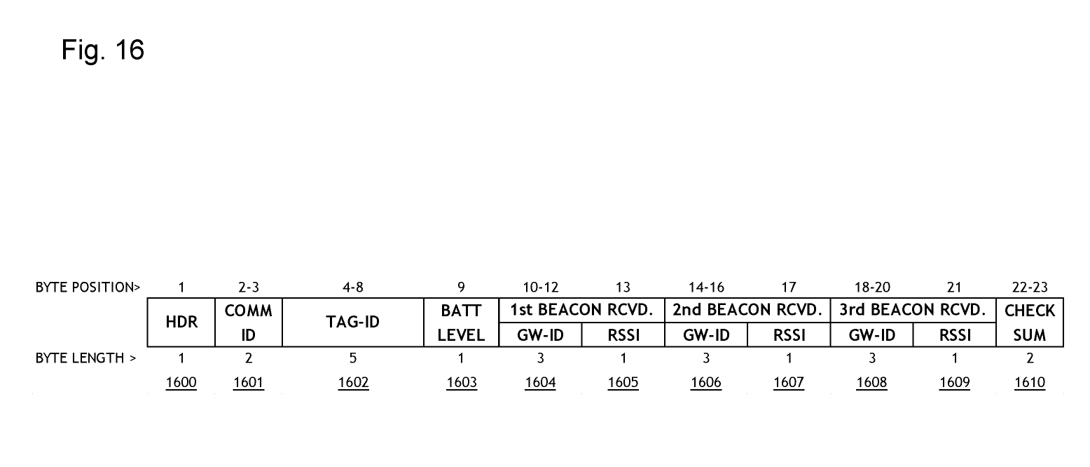

Referring to FIG. 16, shown is an illustration of an exemplary structure of a Tag-INFO 104 data packet 201 containing also information from which Gateway 101 the beacon signal 102 is received together with the RSSI value for each individual Gateway 101. On each embodiment, the amount of beacon signals 102 received depends on how accurate the Tag 103 position is required to be calculated.

As shown in FIG. 16, the Tag-INFO 104 data packet 201 starts with a 1 Byte Header 1600 followed by a 2 Byte Data Packet Communication ID 1601. The Tag-ID 1602 has 5 bytes and battery level 1603 has 1 Byte. In this particular structure, the Tag 103 sends three beacon signals to the Gateways, each containing 3 bytes 1604, 1606, 1608 for the Gateway ID 1501 and 1 byte 1605, 1607, 1609 for the RSSI for each Gateway 101. The data packet 201 ends with a check summary 1610 containing 2 bytes.

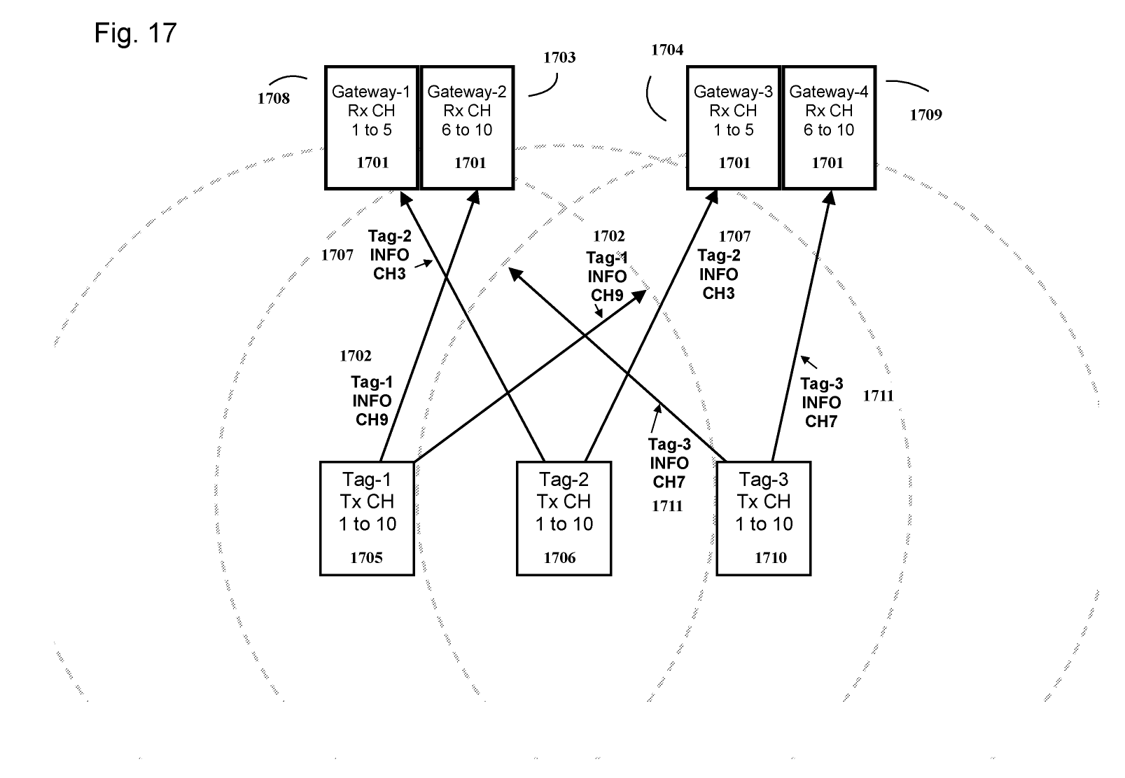

Referring to FIG. 17, shown is how Tags 103 can broadcast over more channels than the Gateway Receiving Channels 1701, to improve and optimize the Tag 103 Ecosystem implementation. As an embodiment, 10 broadcasting/communication channels are implemented on the Tags 103 and the Gateway Receiving Channels 1701. Such a configuration allows for two independent Gateway Receiving Channels 1701 to be placed in the same physical place.

In a preferred embodiment of the present invention, each Gateway Receiving Channel 1701 has five Rx Modules 305 (not shown). By way of example, where two Gateway Receiving Channels are placed together on the same physical place, the five Rx Modules 305 tune to alternate channels.

In another preferred embodiment of the present invention, and by way of example, the Tag 103 is transmitting 104 the data packet 201 on Channel 9 1702 and is received by Gateway-2 1703. A viewer may perceive that the Tag-INFO 104 data packet 201 is not received by Gateway-3 1704 because is physically too far from Tag-1 1705. Tag-2 1706 transmits its Tag-INFO 104 data packet 201 on Channel 3 1707, which is received by Gateway-1 1708 and Gateway-3 1704 and not by Gateway-2 1703 and Gateway-4 1709. On the same way, Tag-3 1710 is transmitting its Tag-INFO 104 data packet 201 on Channel 7 1711, which is received just by the Gateway-4 1709 and not by the Gateway-3 1704. The Tag-3 INFO data packet 1711 is not received by Gateway-2 1703 because is physically too far from Tag-3 1710.

In this structure, each Gateway Receiving Channel 1701 receives only 50% of the total Tag-INFO data packet traffic, so the amount of Tags 103 can be doubled with respect to a system using single Gateway Receiving Channel 11701 per physical point configuration. On other embodiments, a higher number of Rx Modules 305 (not shown) and channels can be used, depending on how big and complex is the Ecosystem required to implement.

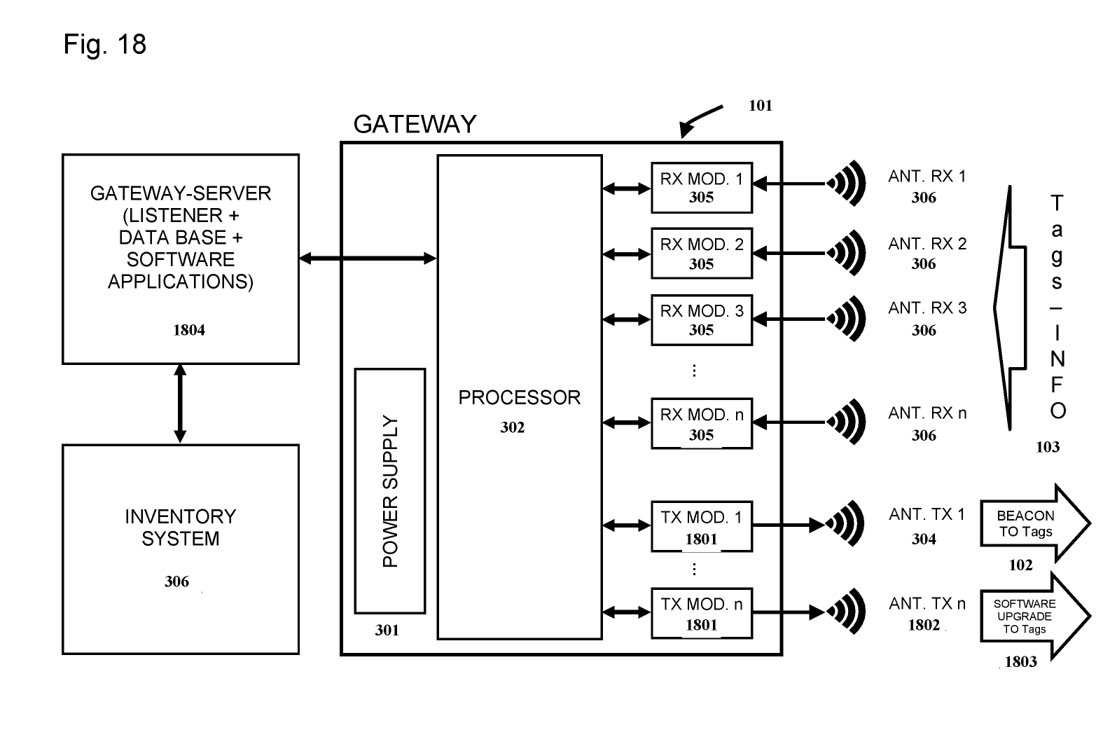

Referring to FIG. 18, shown is one embodiment of a Gateway 101 with multiple broadcasting/transmitting modules. The Gateway 101 is powered by a power supply unit 301, and processes data by way of a processor 302. Multiple transmitter (Tx) modules 1801 and communicate with a multitude of antennas 304, 1802 to facilitate broadcasting beacon signals 102 to the Tags 103 or, where necessary, transmitting software upgrades 1803 to the Tag Ecosystem. The Tx Modules 1801 can be used to broadcast special parameters or system status information to the Tags 103 Receiver modules (Rx) 305 are also present on the Gateway 101 and are coupled with antennas 306 to receive data packets 201 that comprise a data payload, which are transmitted 104 from Tags 103.

Gateway 101 may have more than one receiver (Rx) module 305 comprising more than one tuner (not shown). This allows the Gateway 101 to received signals broadcast on multiple channels or frequencies simultaneously. Alternatively, Gateway 101 may include a single receiver module 305 with programming or hardware capable of extracting multiple data streams from one signal. The specific number of receiver modules 305 may be defined for each specific application. The purpose of each receiver module 305 is to listen for incoming transmissions 104 comprising data packets 201 transmitted by Tags 103. Each receiver module 305 may be tuned to a different frequency channel for receiving data packets 201 that are transmitted 104 at different frequencies. In one embodiment, the frequency at which a given Tag 103 transmits 104 is randomly (or pseudo randomly) selected in order to reduce the likelihood of collisions 202.

Gateway 101 may be connected to a Gateway server 1804 which, in turn, connects to the Inventory System 307. In scenarios where multiple Gateways 101 are used, the Gateway server 1804 manages the communication protocols associated with the beacon signal detection protocols (FIG. 12) of the present invention. The Gateway server 1804 also manages the data received from the Inventory Server 307 so that further processing 302 of the data can take place. The Gateway server 1804 may also track which Tags 103 have successfully communicated with the Gateways 101 within a predetermined time period to determine whether a Tag 103 is present in the system or not. The predetermined time period is set in accordance with an estimated time in which all Tags 103 present within a particular physical location (e.g., a warehouse) are expected to have successfully transmitted 104 with one or more Gateways 101.

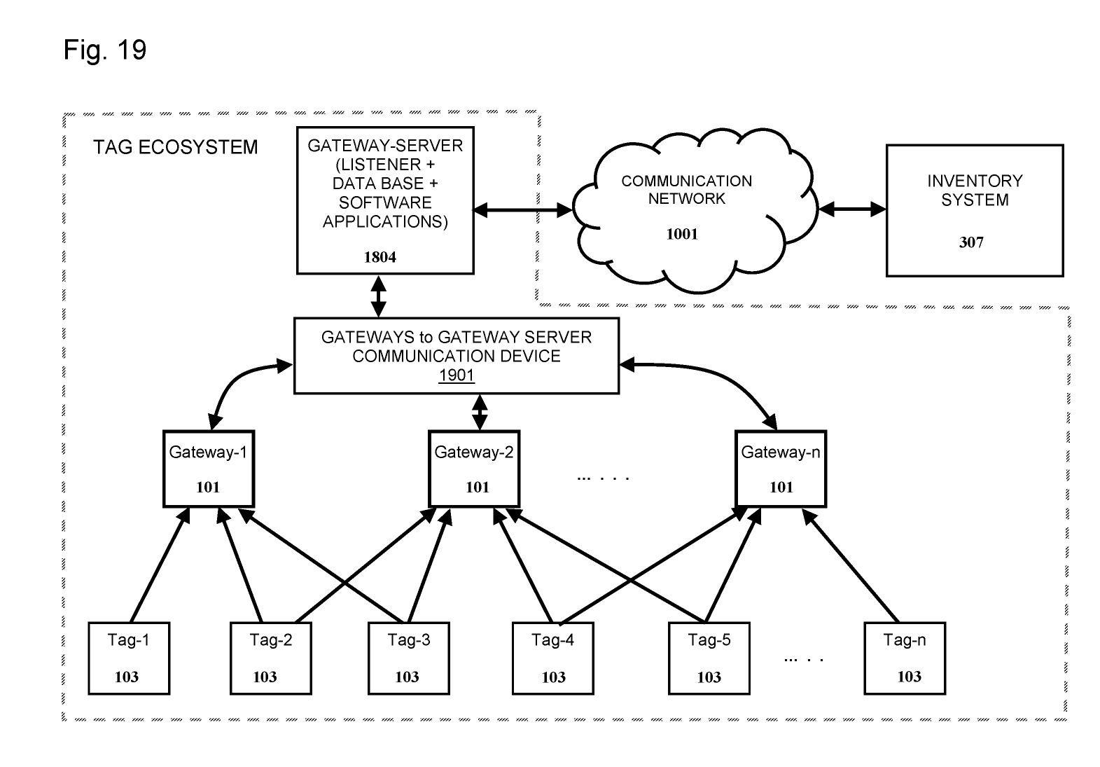

Referring to FIG. 19, shown is an exemplary method for how a Tag 103 communicates with a Gateway Server 1804 having an intermediary Gateway 1901 and multiple Gateways 101. Such a configuration isolates the Tag 103 Ecosystem from other external systems that use information from the Tags 103. In a preferred embodiment of the present invention, the GATEWAY-Server 1084 receives Tag-INFO 104 data packets 201 (not shown) sent from the Tags 103 through the Gateways 101, which is stored within a communication database (not shown) which process the information and readies it for external use. In a preferred embodiment of the present invention, the GATEWAY-Server 1804 can be a query processor to communicate with an external system. The GATEWAY-Server 1804 also receives, stores and process alarm and status/performance information from the Tags 103 and Gateways 101 to alert the operator of the present invention.

As shown in FIG. 19, a the GATEWAY-Server 1804 is located on the boundary of the Tag Ecosystem and provides a means for the Inventory System 307 can communicate with the GATEWAY-Server 1804 to retrieve information about Tags 103 present within a prescribed space, such as a building or warehouse inside a warehouse.

In a preferred embodiment, the GATEWAY-Server 1804 incorporates a Listener software, dedicated to receiving the Tag INFO 104 data packets 201 from all the Gateways 101. The Tag-INFO 104 data packets 201 are stored on a database for real time analysis of the Tag 103 activity. The GATEWAY-Server 1804 also includes a Tag-INFO processor software applications to filter the Tags-INFO 104 data packets 201 to avoid replicate data and/or error data packet 201 caused by collisions 202.

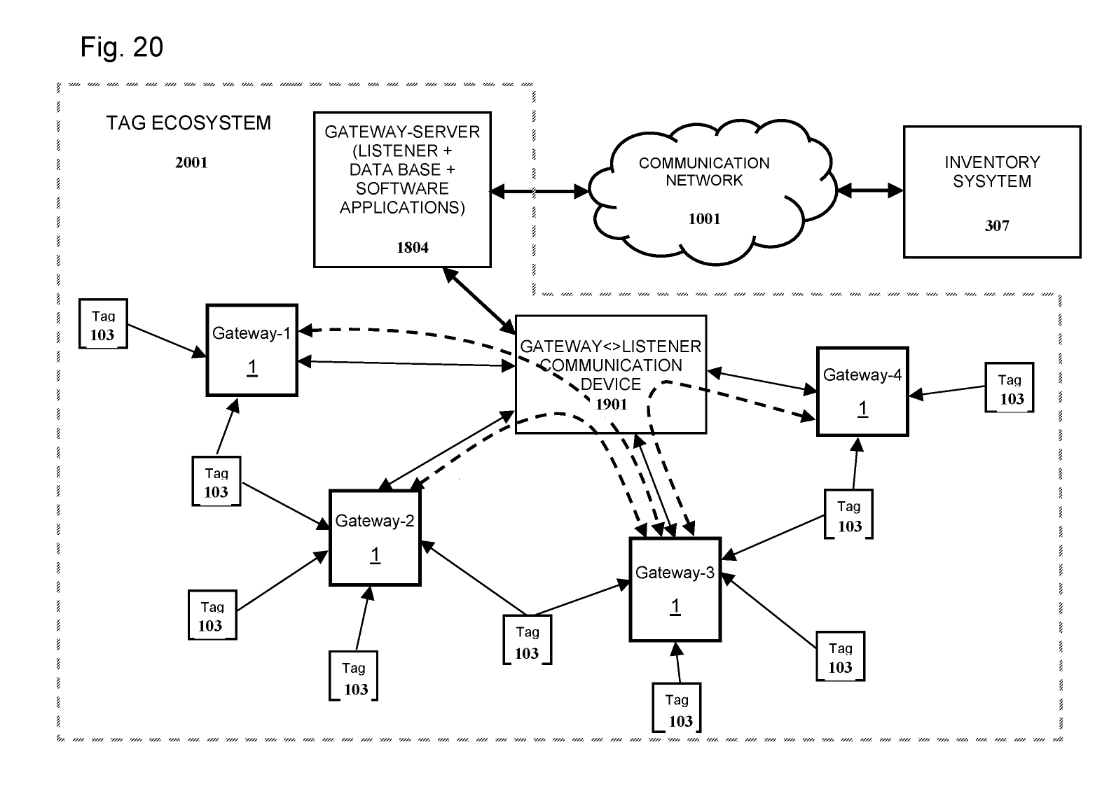

Referring to FIG. 20, an exemplary block diagram is showing how Gateways 101 can communicate between one another to share information to improve the Tag 103 system performance. In one embodiment where a large Tag 103 Ecosystem is implemented, the Gateways 101 can share information about the Tags' 103 status, to avoid sending duplicate information to the GATEWAY-Server 1804 and reduce the data throughput over the communication network 1001. Gateways 101 can be configured to communicate with “neighbor” Gateways 101 located physically close to avoid or minimize Tag-INFO 104 duplication before it is sent to the GATEWAY-Server 1804. The “neighbor” Gateways 101 can share information about their Rx Modules 305 and Tx Modules 1801 and generate alarms to the GATEWAY-Server 1804.

As shown in FIG. 20, an TAG Ecosystem 2001 is shown with a plurality of Tags 103, four Gateways 101, a Gateway Communication Module 1901 to the GATEWAY-Server a GATEWAY-Server 1804, a communication network 1001 between the GATEWAY-Server 1804 and the Inventory system 307 and the Inventory System 307. Each Gateway 101 can communicate with any other Gateway 101 located inside the TAG Ecosystem 2001 to share, request or send information related for example with system status, alarms or any other Gateways 101 sensitive information where no GATEWAY-Server 21804 intervention is required.

In a preferred embodiment, one specific Gateway 101 can retrieve software upgrade or parameters change information from a GATEWAY-Server 1804 located outside the Tag Ecosystem 2001 and Inventory System 307 and distribute the downloaded information to the other Gateways 101 inside the Tag Ecosystem 2001, efficiently.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention generally described herein has been disclosed in connection with a number of embodiments shown and described in detail, various modifications should be readily apparent to those of skill in the art.

1. A method of communication between at least one remote device and at least one central device, the method comprising:
determining on at least one remote device a random amount of sleep time;
causing on at least one remote device to enter a sleep mode for the random amount of sleep time;
causing on at least one remote device to enter a power-on mode after the random amount period of sleep time has elapsed;
causing on at least one remote device to listen, while in the power-on mode, to identify whether a beacon message was sent from at least one central device;
upon detecting on at least one remote device a beacon message from at least one central device, transmitting a response message and causing at least one remote device to return to sleep mode;
upon failing to detect on at least one remote device the beacon message from at least one central device, causing the at least one remote device to return to the sleep mode.

2. The method of claim 1 wherein the at least one remote device, upon failing to detect the beacon message from the at least one central device, transmits the response message before returning to sleep mode.

3. The method of claim 1, wherein the at least one remote device randomly selects a channel on which to transmit the response message.

4. The method of claim 1, wherein the method is repeated until each of the at least one remote devices have successfully transmitted a response message to one of the at least one central devices.

5. The method of claim 1, wherein the beacon messages are broadcast.

6. The method of claim 1, wherein the response messages are broadcast.

7. A method of communication between a central device and a plurality of remote devices, said method comprising:
causing the central device to wait a random amount of time;
causing the central device to transmit a beacon signal to the plurality of remote devices;
causing the central device to receive a response message from at least one of the plurality of remote devices;
at a randomized interval and on a randomized frequency selected from a number of frequencies to which the central device may tune;
upon receiving a signal from a remote device, causing the central device to process the data from within the signal.

8. The method of claim 7, wherein the response message is transmitted on a randomly selected frequency.

9. The method of claim 7, wherein the method is repeated until each of the plurality of remote devices have successfully transmitted a response message to the central device.

10. The method of claim 7, wherein the beacon message is broadcast.

11. A method of communications between a plurality of remote devices and at least one central device, comprising:
at least one central device configured to:
periodically transmit beacon messages;
receive response messages from the plurality of remote devices;
process data from the received messages; and,
a plurality of remote devices having receivers, each configured to:
enter a sleep mode for a random period of time;
power-on the receiver after the random period of time has elapsed;
listen for a predetermined period of time to detect receipt of a beacon message;
upon receipt of the beacon message, transmit a response message and return to sleep mode;
upon expiry of the predetermined period of time, return to sleep mode.

12. The system of claim 11, wherein the at least one central device transmits beacon messages at random predetermined time intervals.

13. The system of claim 11, wherein the at least one remote device randomly selects a frequency and transmits the response message on that frequency.

14. The system of claim 11, wherein the beacon messages and the response messages are broadcast.

15. The system of claim 11, wherein the at least one remote device, upon determining that no beacon message was received, transmits the response message before returning to sleep mode.

16. A method of communication between at least one Remote devices and plurality of Central devices using channel (frequency) groups on the Central Devices.
Remote devices use the whole channel (frequency) defined range
Central devices work in channel (frequency) groups ensuring they cover the full channel (frequency) range.

17. The method of claim 16, wherein there is a plurality of Remote Devices

18. A method of communication between at least one Central Device and a Server device to receive, store and process the data packets received from at least one Remote Devices.

19. The method of claim 18, wherein are at least one Central Device and a plurality of Remote devices.

20. The method of claim 18, wherein there are a plurality of central devices and a plurality of Remote devices.

21. A method of communication between at least one central device to another central device to exchange information.

22. The method of claim 21, wherein at least one central device communicates with a plurality of central devices.

23. The method of claim 21, wherein a plurality of central devices communicates with a plurality of central devices.

24. A method of communication where at least one remote device receives two or more beacon IDs and RSSI signals from varying Central Devices.

25. A method of claim 24 where the remote device transmits a response message containing the received information to at least one Central Device and causing the at least one remote device to return to sleep mode.

26. The method of claim 24, wherein a plurality of remote devices receives two or more beacon IDs and RSSI from varying Central Devices and transmitting a response message containing the received information to at least one central device and causing the at least one remote device to return to sleep mode.
